(19) United States
(12) Patent Application Publication
(10) Pub. No.: US 2025/0307564 A1
(43) Pub. Date: Oct. 2, 2025

(54) INTENT DISCOVERY USING LARGE LANGUAGE MODELS

(71) Applicant: ServiceNow, Inc., Santa Clara, CA (US)

(72) Inventors: Juan Antonio Rodriguez Garcia, Montreal (CA); Christopher Joseph Pal, Montreal (CA); Issam Hadj Laradji, Vancouver (CA); David Vazquez, Montreal (CA)

(21) Appl. No.: 18/625,066

(22) Filed: Apr. 2, 2024

(51) Int. Cl. G06F 40/35; G06F 40/40; G06N 20/00; G10L 15/06; H04M 3/51

(52) U.S. Cl. CPC G06F 40/35; G06F 40/40; G06N 20/00; G10L 2015/0635; H04M 3/51

(57) ABSTRACT

Systems and methods to cause an intent discovery system to identify new user intents without additional training. The system may comprise of two neural networks. The first neural network generates a prompt tailored to a particular domain (e.g., travel), and may include known intents pertinent to the domain selected examples from a training dataset to provide context to the prompt. The second neural network may use this prompt to identify intents from new utterances in the prompt. The identified intents that are not in the list of known intents are then used to update the database.

### TECHNICAL FIELD

The present disclosure relates to identifying intents in utterances to update a known list of intents.

### BACKGROUND

Intent discovery is useful for modern dialogue systems, allowing them to decipher user queries, whether they involve seeking information, making requests, or expressing opinions, and steering the conversation appropriately. Current techniques for identifying intents may be improved.

### SUMMARY

In some implementations, a method of intent discovery includes obtaining an utterance and a corresponding label representative of an intent of the utterance; and generating, using a first large language model on the utterance and the corresponding label, a prompt comprising a task description and an input-label pair. The method may further include modifying the prompt to include one or more of a list of known intents, a few-shot example, or a list of test examples. The method may further include generating, using a second large language model on the modified prompt, a list of predicted intents; and determining that a particular intent in the list of predicted intents is not in the list of known intents. The method may further include updating the list of known intents with the particular intent.

Various implementations of the disclosure may include one or more of the following optional features. In some implementations, the utterance and the corresponding label are retrieved from a training dataset that includes a plurality of utterance-intent pairs for a particular domain. In some implementations, utterances corresponding to the list of known intents are semantically similar to utterances in the list of test examples. In some implementations, an utterance in the few-shot example is semantically similar to an utterance in at least one of the list of test examples. In some implementations, each of the first large language model and the second large language model is a frozen transformer. In some implementations, utterances in the list of known intents and utterances in the few-shot example are of a same domain. In some implementations, the first large language model is to generate the prompt based on a template. In some implementations, the list of test examples includes a plurality of utterances without matching intents, and where at least one of the plurality of utterances is received from a caller via a server in a call center.

In some implementations, a system for intent discovery comprises one or more processors and memory including computer-executable instructions. The one or more processors, when executing computer-executable instructions, cause the system to perform operations that comprises obtaining an utterance and a corresponding label representative of an intent of the utterance; and generating, using a first large language model on the utterance and the corresponding label, a prompt comprising a task description and an input-label pair. The operations may further comprise modifying the prompt to include one or more of a list of known intents, a few-shot example, or a list of test examples; and generating, using a second large language model on the modified prompt, a list of predicted intents. The operations may further comprise determining that a particular intent in the list of predicted intents is not in the list of known intents; and updating the list of known intents with the particular intent.

Various implementations of the disclosure may include one or more of the following optional features. In some implementations, the utterance and the corresponding label is randomly selected from a training dataset, where the training dataset includes a plurality of utterance-intent pairs of a particular domain. In some implementations, the utterance and an utterance in the few-shot example are of the same domain. In some implementations, the first large language model is to generate the prompt based on a template that specifies a format of a response that the second large language model is to return. In some implementations, at least one of a plurality of utterances in the list of test examples is received from a caller via a server in a call center, and the server is to generate a response to the caller using an intent returned by the second large language model based on the at least one utterance. In some implementations, the prompt includes a place holder for the few-shot example to be inserted into the prompt, and one or more instructions instructing the second large language model how to use the few-shot example in discovering intents for the list of test examples. In some implementations, the list of known intents includes at one intent from a training dataset and at least one intent discovered by the second large language model in a previous iteration.

In some implementations, a non-transitory computer-readable storage medium having stored thereon executable instructions, which, when executed by one or more processors of a computer system, cause the computer system to perform operations that comprise obtaining an utterance and a corresponding label representative of an intent of the utterance; and generating, using a first large language model on the utterance and the corresponding label, a prompt comprising a task description and an input-label pair. The operations may further comprise modifying the prompt to include one or more of a list of known intents, a few-shot example, or a list of test examples; and generating, using a second large language model on the modified prompt, a list of predicted intents. The operations may further comprise determining that a particular intent in the list of predicted intents is not in the list of known intents; and updating the list of known intents with the particular intent.

Various implementations of the disclosure may include one or more of the following optional features. In some implementations, the known intents are a subset of a plurality of known intents stored in a training dataset, where the training dataset includes a plurality of utterance-intent pairs of a particular domain. In some implementations, the few-shot example is selected from a few-shot pool that includes a subset of a training dataset, where the training dataset includes a plurality of utterance-intent pairs of a particular domain. In some implementations, the updated list of known intents are to be inserted into the prompt. In some implementations, a server in a call center is to obtain the updated list of known intents and is to generate a response to a caller based on the updated list of known intents and an utterance of the caller.

The details of one or more implementations of the disclosure are set forth in the accompanying drawings and the description below. Other aspects, features, and advantages will be apparent from the description and drawings, and from the claims.

### BRIEF DESCRIPTION OF THE DRAWINGS

Various Implementations of the present disclosure will be described with reference to the drawings, in which:

FIG. 1 illustrates a schematic diagram of an example of an intent discovery system according to one embodiment;

FIG. 2A illustrates a process of creating a prompt by a prompt generator according to an embodiment;

FIG. 2B illustrates a process of discovering intents of utterances according to an embodiment;

FIG. 3 illustrates an example initial prompt provided to a prompt generator according to an embodiment;

FIG. 4 illustrates an example prompt generated by the prompt generator according to an embodiment:

FIG. 5 is a schematic diagram illustrating an example augmented prompt according to an embodiment:

FIG. 6 illustrates a process of discovering intents in utterances according to an embodiment;

FIG. 7 illustrates a process of discovering intents in utterances according to an embodiment;

FIG. 8 illustrates a use case where an intent discovery system may be used according to an embodiment; and

FIG. 9 illustrates a computing system in which various embodiments can be implemented.

### DETAILED DESCRIPTION

In preceding and following descriptions, various techniques are described. For purposes of explanation, specific configurations and details are set forth in order to provide a thorough understanding of possible ways of implementing techniques. However, it will also be apparent that techniques described below may be practiced in different configurations without specific details. Furthermore, well-known features may be omitted or simplified to avoid obscuring techniques being described.

Intent discovery is dynamic since user intents change over time and new digital tools continually emerge, expanding the range of intents. Thus, intent discovery needs to robustly adapt to stay responsive to changing user needs. However, some existing techniques limit approach intent discovery to known classes. These techniques, therefore, do not align well with real-world applications. Other existing techniques approach intent discovery through the application of clustering methods and semi-supervised training. However, the effectiveness of these approaches often hinges on the availability of substantial labeled data and multi-stage training procedures. In addition, implementing such methods and refining their performance through extensive training and validation may be a resource-intensive endeavor.

Thus, the technical problem to be solved is that current techniques for intent discovery are inadequate for real-world applications. These techniques either generate inaccurate results by oversimplifying intents into generic known classes, or rely on using labeled data and resource intensive complex training processes.

To address the problem, various implementations described herein include systems and methods that cause an intent discovery system to identify new user intents without additional training. An intent discovery system comprises two Large Language Models (LLMs). The first LLM generates prompts tailored to a particular domain, such as travel, and may include a list of known intents pertinent to the domain. These known intents may be retrieved from a database. Additionally, each prompt may include selected examples (e.g., utterances) from a training dataset to provide context to the prompt. Further, each prompt may include test data similar to these examples. In some implementations, the second LLM uses these prompts to identify intents from the test data contained within the prompts. Identified intents that are not in the list of known intents are used to update the database. Through multiple iterations with varying test data, the database progressively expands its repository of known intents related to each domain. In some implementations, the test data may be real-world user utterances whose intents needs to be identified.

In some implementations, a method comprises obtaining an utterance and a corresponding label representative of an intent of the utterance; generating, using a first large language model on the utterance and the corresponding label, a prompt comprising a task description and an input-label pair; and modifying the prompt to include one or more of: a list of known intents, a few-shot example, or a list of test examples. The method further comprises generating, using a second large language model on the modified prompt, a list of predicted intents and determining that a particular intent in the list of predicted intents is not in the list of known intents. The method further comprises updating the list of known intents with the particular intent.

In some implementations, a method comprising receiving a prompt generated by a first neural network. The prompt may be updated to include data comprising utterances and a list of intents retrieved from a database. The method further comprises receiving one or more intents from a second neural network, where the second neural network generates the one or more intents in response to receiving the updated prompt. The method further comprises identifying that at least one of the one or more intents is not in the list of intents in the prompt; and updating the database with the at least one identified intent.

The various embodiments described herein provide improvements to computing systems by enabling dynamic adaptation to evolving user needs and the continuous emergence of new digital tools. These embodiments reduce reliance on resource-intensive labeled data and complex training, and facilitate automatic, real-time updates to the intent database, which leads to enhanced efficiency, real-time responsiveness, and a better alignment with real-world complexities and user interactions.

The above summary does not include an exhaustive list of all embodiments in this disclosure. In addition, features in the method claims may be implemented in system claims or computer readable media claims. Each system claim may be implemented as a system configured to perform operations of the respective method. This system may include hardware components such as processors, memory units, and input/output interfaces. The system may also comprise software components including, but not limited to, modules, programs, applications, or instructions stored in a memory and executable by one or more processors. Furthermore, the described methods may be embodied as a non-transitory computer-readable medium containing executable instructions that, when executed by a processor, perform the respective method claims. The non-transitory computer-readable medium includes, but is not limited to, ROM, RAM, CD-ROMs, DVDs, flash memory, or any other optical or magnetic storage device.

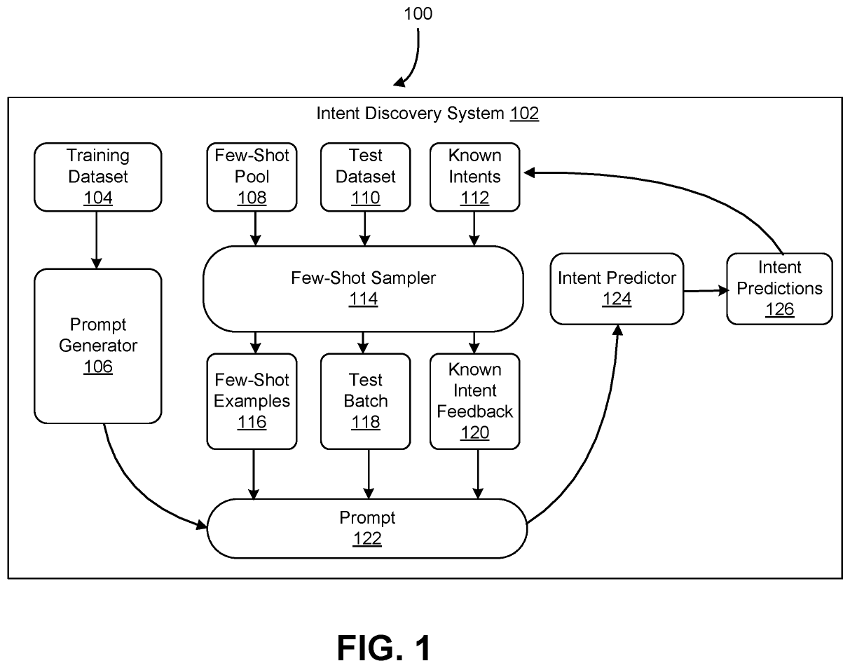

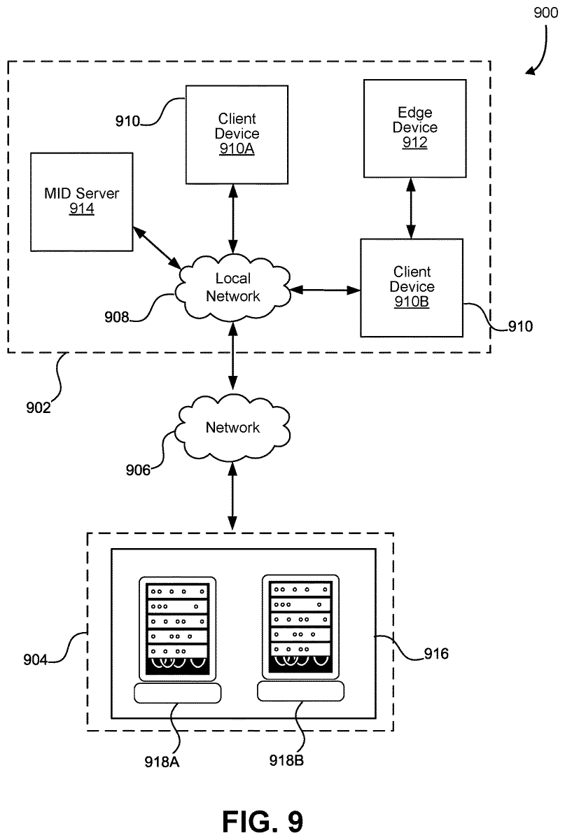

FIG. 1 illustrates a schematic diagram of an example of an intent discovery system 102 according to one embodiment. The intent discovery system 102 may be hosted in a computing system, such as provider platform 904 described in connection with FIG. 9.

As shown in FIG. 1, the intent discovery system 102 comprises an in-context prompt generator 106 and an intent predictor 124, which can be neural networks or machine learning models. In some implementations, both neural networks 106 and 124 may be large language models (LLMs), which have undergone extensive training on vast and diverse text corpora encompassing a wide range of domains and context. The neural networks 106 and 124 therefore include weights and biases that enable them to possess a broad understanding of language, making them adept at handling complex and diverse user inputs. In some implementations, both neural networks 106 and 124 are frozen transformers, where weights and bias in one or more portions of the models remain unchanged during additional training processes, allowing for efficient and stable use of the models.

In some implementations, the prompt generator 106 generates a prompt 122 based on samples received from a training dataset 104. In some implementations, the training dataset 104 may include multiple utterance-intent pairs, each of which includes an “Utterance” (what is said) and an “Intent” (the purpose or meaning behind the utterance). In some implementations, multiple utterances can be mapped to a single known intent in the training dataset 104. In some implementations, the training dataset 104 may include all known intents in a particular domain for a particular organization. In some implementations, a domain refers to a specific subject matter or an area of focus, for example, healthcare, finance, travel, retail, and/or IT support. In some implementations, the training dataset 104 may be represented in raw textual format, such as plain text (.txt) files, JavaScript Object Notation (JSON), or extensible markup language (XML), or database format.

In some implementations, each sample received from the training dataset 104 represents an utterance-intent pair. In some implementations, the samples may be randomly selected from the training dataset 104, with a predetermined number of utterance-intent pairs selected for each known intent, for example, two pairs for each known intent.

In some implementations, the intent discovery system 102 may include one or more software components each with one or more program instructions, which, when executed, perform one or more functions to select the predetermined utterance-intent pairs for each known intent in the particular domain.

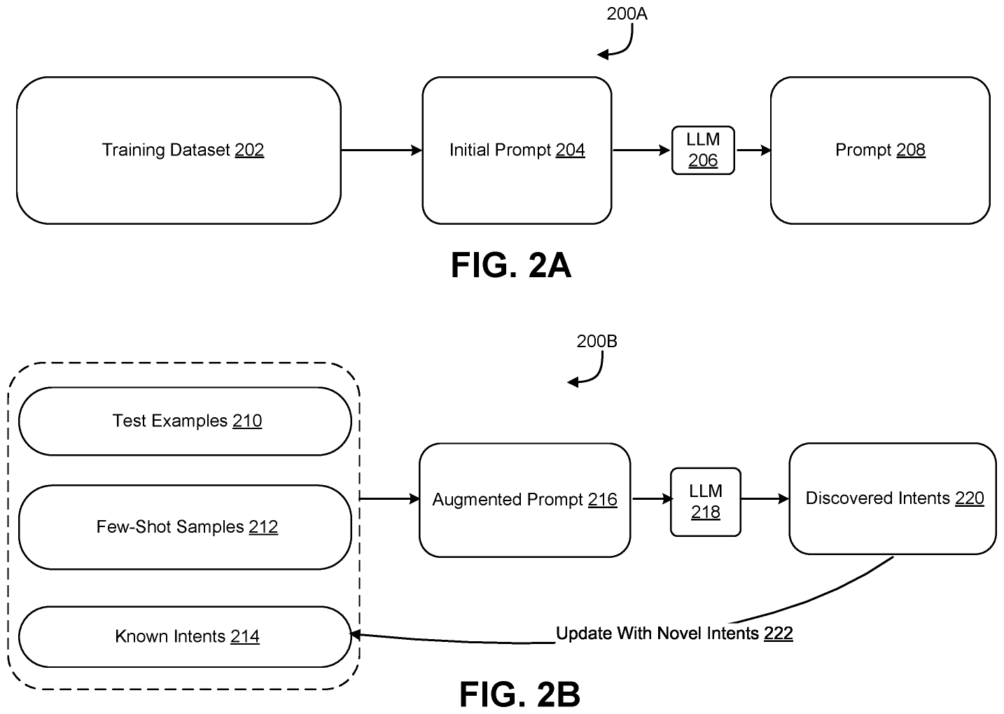

In some implementations, the selected samples provide context for an intent discovery task for a particular domain. The selected samples may be embedded in an initial prompt and used to condition the prompt generator 106 to generate the prompt 122 for the intent predictor 124. An example process of generating the prompt 122 is detailed in FIG. 2A.

In some implementations, the prompt 122 may be represented in a variety of formats, tailored to suit different uses and system requirements. Examples of the formats include plain text, JSON, and XML. In some implementations, the prompt 122 may be embedded in code that may be used in automated testing or integrated systems. In some implementations, the prompt 122 may be in audio or visual formats that cater to multimedia applications.

In some implementations, once the prompt 122 is generated, it may be retained (e.g., saved) in a database or another form of storage in the intent discovery system 102 for future use during inference.

In some implementations, during inference, the prompt 122 may be augmented with additional contextual data gathered by a few-shot sampler 114. This additional contextual data may include one or more few-shot examples 116, known intent feedback 120, and a test batch 118.

In some implementations, the few-shot sampler 114 may include one or more program instructions that, when executed, perform one or more functions to gather the additional data and infuse it into the previously-generated prompt 122. In some implementations, the few-shot sampler 114 may retrieve the one or more few-shot examples 116 from a few-shot pool 108, which includes a subset of the training dataset 104, for example, 10% of the samples for each known intent in the training dataset 104.

In some implementations, the few-shot examples 116 may be randomly selected from the few-shot pool 108, which itself is a subset of the training dataset 104 that represents all intents of a particular domain to an organization. As used herein, few-shot examples 116 are a condensed yet comprehensive representation of the full dataset (e.g., the training dataset 104). In some implementations, the few-shot examples 116 may be selected using a Semantic Few-Shot Sampling (SFS) technique, which finds samples based on embedding similarity with the test batch 118. For example, a K-Nearest Neighbors (KNN) semantic sampling technique may be used, where each utterance in both the few-shot pool 108 and the test batch are embedded into vectors to enable the selection of one or more examples from the few-shot pool 108 for each test-batch utterance, based on a similarity measure (e.g., cosine distance) between the one or more examples and their respective test-batch utterance.

In some implementations, the few-shot examples 116 then may be concatenated with the samples selected from the training dataset 104 to constitute a sequence of samples to be fed to the intent predictor 124.

In some implementations, the known intent feedback 120 is one or more utterance-intent pairs retrieved by the few-shot sampler 114 from known intents 112, which may be stored in a variety of storage formats, such as text, CSV, JSON, XML, EXCEL, PDF, and database. In some implementations, the known intents 112 may either be a copy of, or a subset of, the training dataset 104, augmented with one or more intents identified by the intent predictor 124.

In some implementations, the known intent feedback may include all utterance-intent pairs of the known intents 112 or a subset thereof. In some implementations, to retrieve a subset of the known intents 112, the few-shot sampler 114 may use the KNN semantic sampling technique described earlier to select the subset of the known intents 112 that are semantically similar to the current test batch 118.

In some implementations, an option represented by a variable in the few-shot sampler 114 may be used to select either all the intents in the known intents 112 or use the KNN technique to select just a subset of the known intents 112. When the option is deactivated, all utterance-intent pairs in the known intents 112 are selected by the few-shot sampler 114 and included in the prompt 122. In some implementations, activating the option enables the few-shot sampler 114 to include samples in the prompt 122 that are semantically similar to the test batch 118, optimizing the context length used by the intent predictor 124 and avoiding the need to inject the entire list of known intents into the prompt 122. Thus, the activation of the option allows the few-shot sampler 114 to strike a balance between metric performance and query efficiency.

In some implementations, the test batch 118 is retrieved by the few-shot sampler 114 from a test dataset 110, which may be one or more utterances whose matching intents are to be discovered by the intent predictors 124. In some implementations, the test dataset 110 may be one or more utterances without matching intents. In some implementations, the one or more utterances may be received from a client device, such as client device 910A or 910B described in connection with FIG. 9. In some implementations, the test batch 118 may be a copy of the test dataset 110 or a subset thereof.

In some implementations, the prompt 122 may be constructed by the prompt generator 106 based on a template that precisely defines its content and format. In some implementations, the template may include explicit instructions to instruct the intent predictor 124 to solely predict (discover) intents for utterances without matching intents and avoid predicting intents for utterances with intents (e.g., utterances in the few-shot examples 116). The template also defines a desired output format to simplify parsing by the intent predictor 124.

In some implementations, the prompt 122 may be provided to the intent predictor 124, which generates an intent for each utterance in the test batch 118 contained within the prompt 122. In some implementations, the intent discovery system 102 may update the known intents 112 with the newly discovered intents, which are intent predictions 126, to expand the known intents. These expanded known intents may be used as contextual information by the intent predictor 124 to discover (generate) intents on utterances in subsequent iterations.

FIG. 2A illustrates a process 200A of creating a prompt by a prompt generator according to an embodiment. The process 200A may be performed by one or more software components (not shown in the figures, but described herein) of the intent discovery system 102. The one or more software components comprise one or more program instructions that, when executed, perform the process 200A.

In some implementations, the one or more software components retrieve one or more samples from the training dataset 202, which corresponds to the training dataset 104 described in FIG. 1. The one or more software components construct an initial prompt 204 based on the one or more samples retrieved from the training dataset 202. The one or more software components then provide the initial prompt 204 to an LLM 206 (e.g., the prompt generator 106 described in FIG. 1), which generates a prompt 208. In some implementations, the prompt 208 is generated based on a template, which specifies that the prompt 208 should include both “few-shot samples” and “test samples.”

FIG. 2B illustrates a process 200B of discovering intents of utterances according to an embodiment. The process 200B may be performed by one or more software components (not shown the figures, but described herein) of the intent discovery system 102 as described in FIG. 1. The one or more software components comprise one or more program instructions that, when executed, perform the process 200B. In some implementations, the one or more software components may include the few-shot sampler 114 as described in FIG. 1.

In some implementations, the one or more software components augment the prompt 208 generated by the process 200A with samples from few-shot samples 212 and intents from known intents 214 to create an augmented prompt 216. In some implementations, the one or more software components additionally incorporate into the augmented prompt 216 one or more utterances from test examples 210, which are utterances whose intents are to be discovered by an LLM 218 (e.g., the intent predictor 124 described in FIG. 1).

In some implementations, the one or more software components provide the augmented prompt 216 as input to the LLM 218, which generates discovered intents 220. The one or more software components then update 222 the known intents 214 with the discovered novel intents 220.

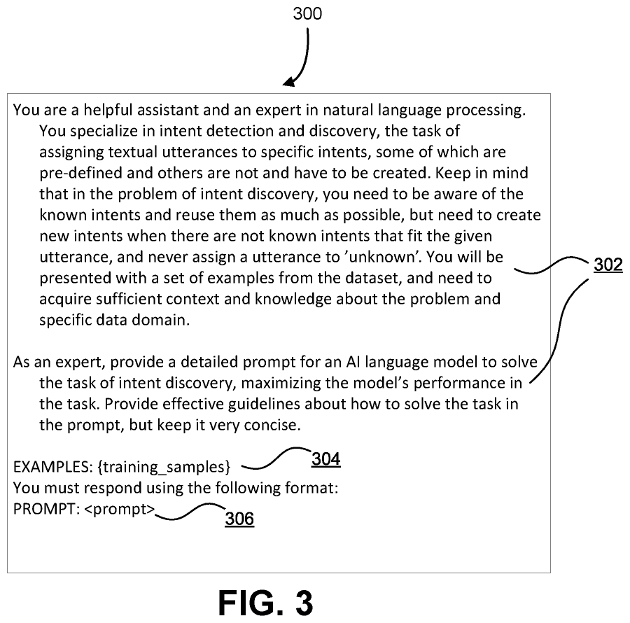

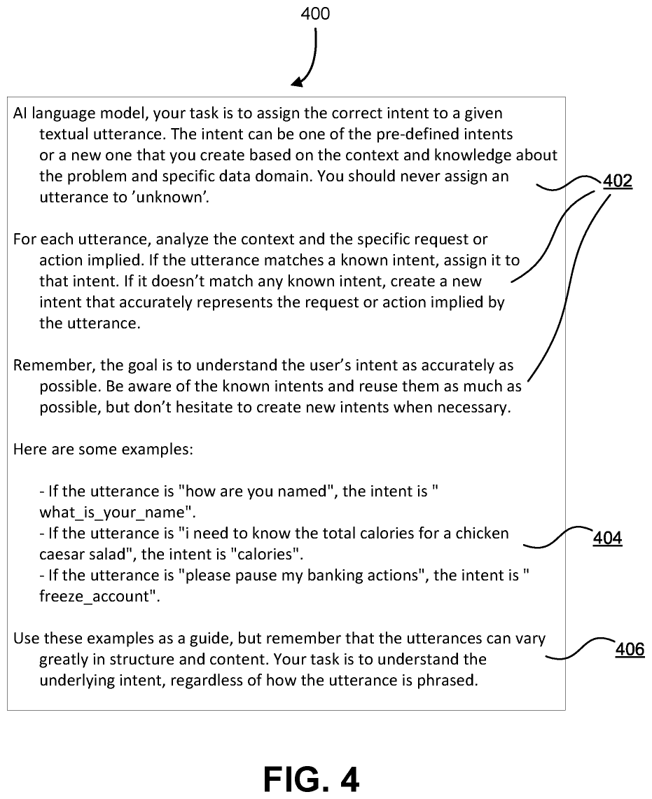

FIG. 3 illustrates an example initial prompt 30) provided to a prompt generator according to an embodiment. The prompt 300 includes instructions 302, training samples 304, and a response format 306. As shown, the instructions 302 may be a task description that instructs a prompt generator (e.g., the prompt generator 106 described in FIG. 1) to generate a prompt for use by another LLM (e.g., the intent predictor 124 described in FIG. 1). The prompt 300 may include the training samples 304 and instructs the prompt generator to respond in a specific format as indicated by the response format 306. In some implementations, the training samples may be retrieved from a training dataset (e.g., the training dataset 104 described in FIG. 1). The initial prompt 300 may be provided as input to the prompt generator, which responds with another prompt, as shown in FIG. 4.

FIG. 4 illustrates an example prompt 400 generated by the prompt generator 106 according to an embodiment. The prompt 400 may include instructions 402 and 406 instructing an LLM (e.g., the intent predictor 124) to discover intents for utterances using samples 404 as a guide. In some implementations, the samples 404 are the same samples 304 as described in FIG. 3.

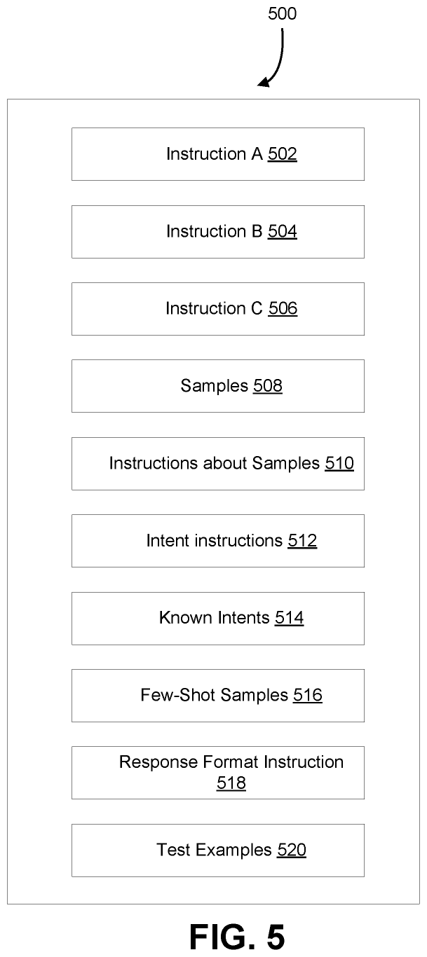

FIG. 5 is a schematic diagram illustrating an example augmented prompt 500 according to an embodiment. In some implementations, the augmented prompt 500 is originally generated by an LLM (e.g., the prompt generator 106 in FIG. 1) and then augmented, e.g., by the few-shot sampler 114 in FIG. 1 with additional contextual information d (e.g., known intents and few-shot samples) as well as utterances whose intents are to be discovered by another LLM (e.g., the intent predictor 124).

As shown, the augmented prompt 500 may include several instructions 502, 504, and 506 instructing the other LLM to discover intents for the embedded utterances in the augmented prompt 500 in a specific manner. In some implementations, the instructions 502, 504, and 506 constitute a task description.

An example of instruction A 502 is as follows: “AI language model, your task is to assign the correct intent to a given textual utterance. The intent can be one of the pre-defined intents or a new one that you create based on the context and knowledge about the problem and specific data domain. You should never assign an utterance to ‘unknown.”

An example of instruction B 504 is as follows: “For each utterance, analyze the context and the specific request or action implied. If the utterance matches a known intent, assign it to that intent. If it doesn't match any known intent, create a new intent that accurately.”

An example of instruction C 506 is as follows: “Remember, the goal is to understand the user's intent as accurately as possible. Be aware of the known intents and reuse them as much as possible, but don't hesitate to create new intents when necessary.”

As further shown, the augmented prompt 500 may include samples 508 that are retrieved from a training dataset (e.g., the training dataset 104 in FIG. 1). In an example, the samples 508 correspond to samples 404 described in FIG. 4.

In some implementations, the augmented prompt 500 further includes an instruction 510 regarding how the LLM should use the samples 508. For example, the instruction 510 may state: “Use these examples as a guide, but remember that the utterances can vary greatly in structure and content. Your task is to understand the underlying intent, regardless of how the utterance is phrased.”

In some implementations, the augmented prompt 500 may further include additional instructions 512 regarding how the LLM should discover new intents from the utterances embedded in the augmented prompt 500. For examples, the instructions 512 may state: “Make sure each intent is only between one and three words, and as short and reusable as possible. Use the same format as the context examples. Don't classify the examples below CONTEXT EXAMPLES. Only classify the test examples below TEST EXAMPLES. You are prohibited to assign intents to ‘unknown’. Instead, create a new intent. Don't discover a new intent if you have already discovered one that is similar. Make sure that the intents are not very generic, you can be fine-grained. Use the following list of known intents to keep reference, reuse them as much as possible:”.

In some implementations, the augmented prompt 500 may further include a list of known intents 514, which is a subset of known intents 112 as described in FIG. 1. For example, the known intents 514 may include: no, what_is_your_name, calories, shopping_list, freeze_account, pto_request_status, current_location, where_are_you_from, income, gas, confirm_reservation, maybe, improve_credit_score, book_hotel, repeat, apr, damaged_card, tire_pressure, balance, share_location, what_are_your_hobbies, insurance_change, car_rental, smart_home, gas_type, yes, pto_used, replacement_card_duration, order_status, cancel, restaurant_suggestion, rollover_401k, change_accent, redeem_rewards, credit_score, reminder, restaurant_reviews, meeting_schedule, meal_suggestion, exchange_rate, directions, flight status, calendar, do_you_have_pets, alarm, travel_suggestion, update_playlist, ingredients_list, travel_notification, what_can_i_ask_you, w2, report_lost_card, book_flight, distance, thank_you, travel_alert, calculator, make_call, roll_dice, pto_balance, how_old_are_you, international_visa, how_busy, time, are_you_a_bot, timezone, change_user_name, mpg, insurance, payday, vaccines, fun_fact, report_fraud, pto_request, taxes, restaurant_reservation, measurement_conversion, last_maintenance, play_music, application_status, credit_limit_change, change_speed, date, who_made_you, pin_change, spending_history, definition, reminder_update, change_ai_name, tire_change, order, account_blocked, calendar_update, routing, cook_time, food_last, interest_rate, greeting, user_name, todo_list, ingredient_substitution, schedule_maintenance, shopping_list_update, transactions, rewards_balance, credit_limit, carry_on, expiration_date, change_language, text, next_holiday, who_do_you_work_for.

In some implementations, the augmented prompt 500 may further include one or more few-shot samples 516, which correspond to the few-shot examples 116 as described in FIG. 1. For example, the few-shot samples may include: Utterance: please remind me later, Intent: reminder_update; Utterance: i want to know what health plan i'm currently on, Intent: insurance; Utterance: do you work for another individual, Intent: who_do_you_work_for; Utterance: tell me my health plan, Intent: insurance; Utterance: is there an insurance plan for my health, Intent: insurance; Utterance: are you working for another person or entity, Intent: who_do_you_work_for; Utterance: i'm ready to put in the order for everything on my shopping list, Intent: order; Utterance: get everything on my shopping list, Intent: order; Utterance: i'd like to you order everything that's on my shopping list, Intent: order; Utterance: it is damaging to my credit score if i miss one credit card payment, Intent: improve_credit_score.

Additionally, in an embodiment, the augmented prompt 500 may include a response format instruction 518 that instructs to the LLM to respond in a particular format. For example, the response format instruction 518 may state: “RESPONSE FORMAT: ID: <i>, Utterance: <content>, Intent: <intent> Use the same ID in the test example.”

In some implementations, the augmented prompt 500 may include test examples 520, which are one or more utterances whose intention (s) needs to be discovered by the LLM. For example, the test examples 520 may include: ID:0, is there another person you work for; ID:1, does tartine in san francisco take reservations; ID:2, what is the traffic like on the road to downtown dallas; ID:3, what do you think the meaning of life is; ID:4, what is the square root of 80; ID:5, is the friday's full after 4; ID:6, i'm going to need an uber for 4 people to go to patty's bar; ID:7, place an order for my entire shopping list; ID:8, what is the traffic like on the way to town; ID:9, please spell doctor; ID:10, tell my travel agency i'm in canada the entire week of the 6th to the 13th; ID:11, i need help with some fun tourist things to do in tokyo; ID:12, please remind me at a later time; ID:13, what specific health plan do i have; ID:14, can i harm my credit if i miss a car payment; ID:15, please call mark.

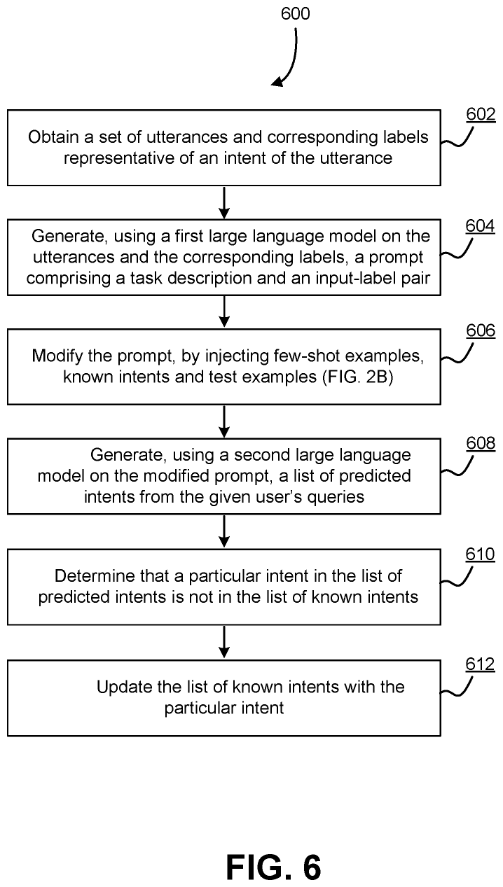

FIG. 6 illustrates a process 600 of discovering intents in utterances according to an embodiment. The process 600 may be performed by a processing logic that includes software, hardware or a combination therefor. For example, the process 600 may be performed by one or more software components in the intent discovery system 102 as described in FIG. 1.

In operation 602, the processing logic obtains a set of utterances and corresponding labels representative of an intent of the utterance. The utterances and the labels are obtained from a training dataset to indicate a domain and contextual information. Both the utterances and the labels representative of the intent may be in either text or audio format. The draining dataset may include a plurality of utterance-intent pairs of one or more domain or multiple domains. As an example, a domain refers to a specific subject matter or an area of focus, such as healthcare, finance, travel, retail, and IT support. In some implementations, the processing logic obtains one utterance and one corresponding label representative of an intent of the utterance from the training dataset to indicate a domain and contextual information.

In operation 604, the processing logic generates, using a first large language model on the utterance and the corresponding label, a prompt comprising a task description and an input-label pair. The first large language model generates the prompt based on a pre-determined template that defines contents and format of the prompt. The input-label is an utterance-intent pair that provides a context information (e.g., domain information) for the task described by the task description.

The above operations use the utterance and its corresponding label to gain a understanding of context, thus improving the accuracy of prompt generation. The task description and input-label pairs are used to guide the second model in accurately detecting and categorizing intents.

In operation 606, the processing logic modifies the prompt to include one or more of: a list of known intents, a few-shot example, or a list of test examples, as shown in FIG. 2B. The list of known intents includes one or more intents from a training dataset and one or more intents discovered by the second large language model in one or more previous iterations. The few-shot example may be selected from a few-shot pool that was prepopulated with utterance-intent pairs extracted from the training dataset. The list of test examples are utterances whose intents are to be discovered by the second language model.

In this operation, the known intents in the prompt provide a reference framework, helping the second language model to accurately classify familiar scenarios, and the few-shot examples serves as concise yet effective learning material for the second language model to discover new intents. The test examples may provide new, unclassified scenarios for the language model to extend its understanding and detection capabilities to novel contexts.

In operation 608, the processing logic generates, using a second large language model on the modified prompt, a list of predicted intents. The list of predicted intents are discovered intents for the utterances in the list of text example, which may or may not be in the list of known intents.

In operation 610, the processing logic determines that a particular intent in the list of predicted intents is not in the list of known intents. In this operation, the processing logic performs an analysis to identify any intents within the list of predicted intents that are not currently included in the list of known intents. This operation is to recognize new or emerging user intents that the system has not encountered before.

In operation 612, the processing logic updates the list of known intents with the particular intent. In this operation, the processing logic may add any such identified new intents to the list of known intents. This operation expands the system's repository of recognized intents, thereby enhancing its future ability to accurately identify and categorize similar intents in subsequent interactions. This ongoing process of identification and update enables the system to continuously evolve and remain effective in identifying a diverse range of user intents.

The operations in the process 600 collectively improve the system's ability to identify intents of utterances using the input-label pair, the few-shot example, and the task description. This represents a substantial improvement over conventional systems because the process 600 is an automatic process that continuously identifies new intents from future utterances (e.g., utterances from users who initiates calls to a call center) and expands the list of known intents, without requiring neither neural network involved in the process 600 to undergo additional training.

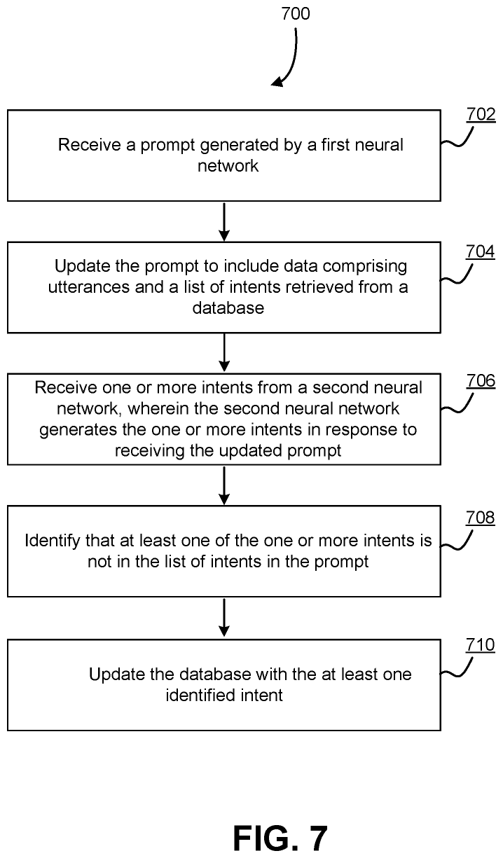

FIG. 7 illustrates a process 700 of discovering intents in utterances according to an embodiment. The process 700 may be performed by a processing logic that includes software, hardware or a combination therefor. For example, the process 700 may be performed by one or more software components in the intent discovery system 102 as described in FIG. 1.

In operation 702, the processing logic receives a prompt generated by a first neural network. In this embodiment, the prompt has been created by the first neural network, such as a large language model, specifically for a given domain. The structure and content of the prompt are determined by a domain-specific template, as depicted in FIG. 5. This template dictates the elements to be included in the prompt. Once generated, this prompt can be repeatedly used for discovering (predicting or identifying) the intents of various utterances within the same domain for which it was originally created.

In operation 704, the processing logic updates the prompt to include data comprising one or more utterances and a list of intents retrieved from a database. This list of intents is known intents in the domain. In some implementations, the utterances are received from a user who initiates a call to a call center. In some implementations, the one or more utterances correspond to the test examples descried in FIG. 6.

In operation 706, the processing logic receives one or more intents from a second neural network. In this operation, the one or more intents are generated by the second neural network (e.g., a large language model) for the one or more utterances included in the prompt. In some implementations, the prompt may include additional contextual information, e.g., one or more few-shot examples and a detailed task description as described in the process 600. In some implementations, the processing logic may send the one or more intents for the one or more utterances to a server (e.g., in a call center) for use in a dialogue with the user who initiates the call with the call center as described in operation 704.

In operation 708, the processing logic identifies that at least one of the one or more intents is not in the list of intents in the prompt. In operation 710, the processing logic updates the database with the at least one identified intent. These two operations expand the known intents in the database such that the known intents can provide more context for the second language model to identify new intents in future utterances.

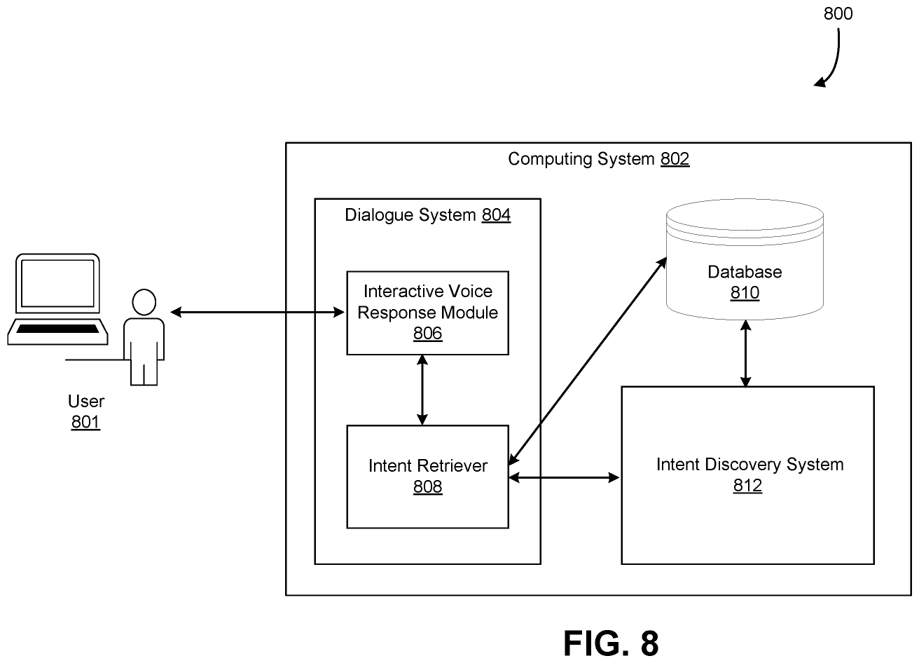

FIG. 8 illustrates a use case where an intent discovery system may be used according to an embodiment.

In this embodiment, an intent discovery system 812 is provided in a computing system 802. The intent discovery system 812 corresponds to the intent discovery system 102 as described in FIG. 1. However, in an embodiment, the intent discovery system 812 does not include a prompt generator such as the prompt generator 106, or a training dataset such as the training dataset 104. Instead, the intent discovery system 812 includes a plurality of prompts that have been already generated such as the prompt 122 in described FIG. 1 for various domains. Further, in an embodiment, the computing system 802 corresponds to the provider platform 904 described in FIG. 9.

As shown, a user 801 (e.g., a customer) initiates a call to a dialogue system 804, which may be situated in a various settings, such as a call center. The user may make an utterance indicating their request to an interactive voice response (IVR) module 806, which needs an intent of the utterance to formulate an appropriate response to the user 801.

In some implementations, the IVR module 806 may send the utterance to an intent retriever 808, which may use a pre-trained neural network model or another mechanism to determine whether an intent matching the utterance exists in a database 810 that stores known intents. If a match is found, the intent retriever 808 responds to the IVR module 806 with the matching intent. If no matching intent is found, the intent retriever 808 sends the utterance to the intent discovery system 812, which may select a prompt from the plurality of prompts that matches a domain of the utterance.

In some implementations, based on the selected prompt, the intent discovery system 812 may discover an intent and respond to the intent retriever 808 with the discovered intent. The intent retriever 808 in turn may return the intent to the IVR module 806, which uses the intent to formulate a response to the user 801. In some implementations, the discovered intent is then stored in the database 810 since the intent retriever has already determined that it is not in the database.

FIG. 9 illustrates a computing system 900 in which various embodiments can be implemented. The computing system 900 may include a client network 902 and a provider platform 904 that are operably connected via a network 906 (e.g., the Internet). In some implementations, the provider platform 904 may be used to host the intent discovery system 102 described in connection with FIG. 1.

In some implementations, the client network 902 may be a private local network 908, such as a local area network (LAN) connecting a variety of network devices that include, but are not limited to, switches, servers, and routers. In some implementations, the client network 902 can comprise an enterprise network that can include one or more LANs, virtual networks, data centers, and/or other remote networks. In some implementations, the client network 902 can be operably connected to one or more client devices 910 such as example client device 910A and 910B so that the client devices 910 are able to communicate with each other and/or with the provider platform 904. In some implementations, the client devices 910 can be computing systems and/or other types of computing devices generally referred to as Internet of Things (IoT) devices that can access cloud computing services, for example, via a web browser application or via an edge device 912 that may act as a gateway between one or more client devices 910 and the provider platform 904 (e.g., second client device 910B). In some implementations, the client network 902 can include a management, instrumentation, and discovery (MID) server 914 that facilitates communication of data between the network hosting the provider platform 904, other external applications, data sources, and services, and the client network 902. In some implementations, the client network 902 may also include a connecting network device (e.g., a gateway or router) or a combination of devices that implement a customer firewall or intrusion protection system.

In at least one embodiment, one or more of the client devices 910 may be configured with a display that provides an interface for receiving input from a user or a virtual entity. In some implementations, one or more computing networks within network 906 can comprise wired and/or wireless programmable devices that operate in the electrical and/or optical domain. For example, network 906 may include wireless networks, such as cellular networks (e.g., Global System for Mobile Communications (GSM) based cellular network), WIN networks, and/or other suitable radio-based networks. The network 906 may also employ any suitable network communication protocols, such as Transmission Control Protocol (TCP), Internet Protocol (IP), and the like. In some implementations, network 906 may include a variety of network devices, such as servers, routers, network switches, and/or other suitable network hardware devices configured to transport data over the network 906.

In some implementations, the provider platform 904 may be a remote network (e.g., a cloud network) that is able to communicate with the client devices 910 via the client network 902 and network 906. In some implementations, the provider platform 904 can comprise a configuration management database (CMDB) platform. In some implementations, the provider platform 904 provides additional computing resources to the client devices 910 and/or the client network 902. For example, by utilizing the provider platform 904, in some examples, users of the client devices 910 are able to build and execute applications for various enterprise, IT, and/or other organization-related functions. In one embodiment, the provider platform 904 can be implemented on the one or more data centers 916, where each data center 916 can correspond to a different geographic location in some examples. In some implementations, one or more the data centers 916 includes a plurality of servers 918A-918B (also referred to in some examples as application nodes, virtual servers, application servers, virtual server instances, application instances, application server instances, or the like), where each server 918 can be implemented on a physical computing system, such as a single electronic computing device (e.g., a single physical hardware server) or across multiple-computing devices (e.g., multiple physical hardware servers). Examples of servers 918 can include a virtual server, a web server (e.g., a unitary Apache installation), an application server (e.g., a unitary Java Virtual Computer), and/or a database server. In at least one embodiment, at least one of the plurality of servers 918 may host the database storing CIs of the computing system 900.

To utilize computing resources within the provider platform 904, in an embodiment, network operators may choose to configure the data centers 916 using a variety of computing infrastructures. In some implementations, one or more of the data centers 916 can be configured using a multi-instance cloud architecture to provide every customer with its own unique customer instance or instances. For example, a multi-instance cloud architecture of some embodiments can provide each customer instance with its own dedicated application server and dedicated database server. In some examples, the multi-instance cloud architecture could deploy a single physical or virtual server 918 and/or other combinations of physical and/or virtual servers 918, such as one or more dedicated web servers, one or more dedicated application servers, and one or more database servers, for each customer instance. In some implementations of a multi-instance cloud architecture, multiple customer instances can be installed on one or more respective hardware servers, where each customer instance is allocated certain portions of the physical server resources, such as computing memory, storage, and processing power. By doing so, in some examples each customer instance has its own unique software stack that provides the benefit of data isolation, relatively less downtime for customers to access the provider platform 904, and customer-driven upgrade schedules.

In some embodiments, the provider platform 904 includes a computer-generated database management server that receives, via network 906 and/or an internal network within or across different data centers, computer-generated data for storage and analysis. For example, log entries can be sent from client devices/servers 910, MID server 914 (e.g., agent server acting as the intermediary in client network 902 to facilitate access to client network 902 by the network hosting the provider platform 904), and/or servers in data centers 916 to a log management server in data centers 916.

Although FIG. 9 illustrates a specific embodiment of a cloud computing system 900, the disclosure is not limited to the specific embodiments illustrated in FIG. 9. For instance, although FIG. 9 illustrates that the provider platform 904 is implemented using data centers, other embodiments of the provider platform 904 are not limited to data centers and can utilize other types of remote network infrastructures. Some embodiments may combine one or more different virtual servers into a single virtual server. The use and discussion of FIG. 9 are only examples to facilitate ease of description and explanation and are not intended to limit the disclosure to the specific examples illustrated therein. In some implementations, the respective architectures and frameworks discussed with respect to FIG. 9 can incorporate suitable computing systems of various types (e.g., servers, workstations, client devices, laptops, tablet computers, cellular telephones, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

One aspect of the disclosure includes a method of intent discovery, where the method includes obtaining an utterance and a corresponding label representative of an intent of the utterance; and generating, using a first large language model on the utterance and the corresponding label, a prompt comprising a task description and an input-label pair. The method may further include modifying the prompt to include one or more of a list of known intents, a few-shot example, or a list of test examples. The method may further include generating, using a second large language model on the modified prompt, a list of predicted intents; and determining that a particular intent in the list of predicted intents is not in the list of known intents. The method may further include updating the list of known intents with the particular intent.

With regard to this aspect, implementations of the disclosure may include one or more of the following optional features. In some implementations, the utterance and the corresponding label are retrieved from a training dataset that includes a plurality of utterance-intent pairs for a particular domain. In some implementations, utterances corresponding to the list of known intents are semantically similar to utterances in the list of test examples. In some implementations, an utterance in the few-shot example is semantically similar to an utterance in at least one of the list of test examples. In some implementations, each of the first large language model and the second large language model is a frozen transformer. In some implementations, utterances in the list of known intents and utterances in the few-shot example are of a same domain. In some implementations, the first large language model is to generate the prompt based on a template. In some implementations, the list of test examples includes a plurality of utterances without matching intents, and where at least one of the plurality of utterances is received from a caller via a server in a call center.

Another aspect of the disclosure includes a system for intent discovery, where the system comprise one or more processors and memory including computer-executable instructions. The one or more processors, when executing computer-executable instructions, cause the system to perform operations that comprises obtaining an utterance and a corresponding label representative of an intent of the utterance; and generating, using a first large language model on the utterance and the corresponding label, a prompt comprising a task description and an input-label pair. The operations may further comprise modifying the prompt to include one or more of a list of known intents, a few-shot example, or a list of test examples; and generating, using a second large language model on the modified prompt, a list of predicted intents. The operations may further comprise determining that a particular intent in the list of predicted intents is not in the list of known intents; and updating the list of known intents with the particular intent.

With regard to this aspect, implementations of the disclosure may include one or more of the following optional features. In some implementations, the utterance and the corresponding label is randomly selected from a training dataset, where the training dataset includes a plurality of utterance-intent pairs of a particular domain. In some implementations, the utterance and an utterance in the few-shot example are of the same domain. In some implementations, the first large language model is to generate the prompt based on a template that specifies a format of a response that the second large language model is to return. In some implementations, at least one of a plurality of utterances in the list of test examples is received from a caller via a server in a call center, and the server is to generate a response to the caller using an intent returned by the second large language model based on the at least one utterance. In some implementations, the prompt includes a place holder for the few-shot example to be inserted into the prompt, and one or more instructions instructing the second large language model how to use the few-shot example in discovering intents for the list of test examples. In some implementations, the list of known intents includes at one intent from a training dataset and at least one intent discovered by the second large language model in a previous iteration.

Another aspect of the disclosure includes a non-transitory computer-readable storage medium having stored thereon executable instructions, which, when executed by one or more processors of a computer system, cause the computer system to perform operations that comprise obtaining an utterance and a corresponding label representative of an intent of the utterance; and generating, using a first large language model on the utterance and the corresponding label, a prompt comprising a task description and an input-label pair. The operations may further comprise modifying the prompt to include one or more of a list of known intents, a few-shot example, or a list of test examples; and generating, using a second large language model on the modified prompt, a list of predicted intents. The operations may further comprise determining that a particular intent in the list of predicted intents is not in the list of known intents; and updating the list of known intents with the particular intent.

With regard to this aspect, implementations of the disclosure may include one or more of the following optional features. In some implementations, the known intents are a subset of a plurality of known intents stored in a training dataset, where the training dataset includes a plurality of utterance-intent pairs of a particular domain. In some implementations, the few-shot example is selected from a few-shot pool that includes a subset of a training dataset, where the training dataset includes a plurality of utterance-intent pairs of a particular domain. In some implementations, the updated list of known intents are to be inserted into the prompt. In some implementations, a server in a call center is to obtain the updated list of known intents and is to generate a response to a caller based on the updated list of known intents and an utterance of the caller.

The various embodiments further can be implemented in a wide variety of operating environments, which in some cases can include one or more user computers, computing devices or processing devices that can be used to operate any of a number of applications. In some implementations, user or client devices include any of a number of computers, such as desktop, laptop or tablet computers running a standard operating system, as well as cellular (mobile), wireless and handheld devices running mobile software and capable of supporting a number of networking and messaging protocols, and such a system also includes a number of workstations running any of a variety of commercially available operating systems and other known applications for purposes such as development and database management. In some implementations, these devices also include other electronic devices, such as dummy terminals, thin-clients, gaming systems and other devices capable of communicating via a network, and virtual devices such as virtual machines, hypervisors, software containers utilizing operating-system level virtualization and other virtual devices or non-virtual devices supporting virtualization capable of communicating via a network.

In some implementations, a system utilizes at least one network that would be familiar to those skilled in the art for supporting communications using any of a variety of commercially available protocols, such as Transmission Control Protocol/Internet Protocol (“TCP/IP”), User Datagram Protocol (“UDP”), protocols operating in various layers of the Open System Interconnection (“OSI”) model, File Transfer Protocol (“FTP”), Universal Plug and Play (“UpnP”), Network File System (“NFS”), Common Internet File System (“CIFS”) and other protocols. The network, in an embodiment, is a local area network, a wide-area network, a virtual private network, the Internet, an intranet, an extranet, a public switched telephone network, an infrared network, a wireless network, a satellite network, and any combination thereof. In some implementations, a connection-oriented protocol is used to communicate between network endpoints such that the connection-oriented protocol (sometimes called a connection-based protocol) is capable of transmitting data in an ordered stream. In some implementations, a connection-oriented protocol can be reliable or unreliable. For example, the TCP protocol is a reliable connection-oriented protocol. Asynchronous Transfer Mode (“ATM”) and Frame Relay are unreliable connection-oriented protocols. Connection-oriented protocols are in contrast to packet-oriented protocols such as UDP that transmit packets without a guaranteed ordering.

In some implementations, the system utilizes a web server that runs one or more of a variety of server or mid-tier applications, including Hypertext Transfer Protocol (“HTTP”) servers, FTP servers, Common Gateway Interface (“CGI”) servers, data servers, Java servers, Apache servers, and business application servers. In some implementations, the one or more servers are also capable of executing programs or scripts in response to requests from user devices, such as by executing one or more web applications that are implemented as one or more scripts or programs written in any programming language, such as Java®, C, C# or C++, or any scripting language, such as Ruby, PHP, Perl, Python or TCL, as well as combinations thereof. In some implementations, the one or more servers also include database servers, including without limitation those commercially available from Oracle®, Microsoft®, Sybase®, and IBM® as well as open-source servers such as MySQL, Postgres, SQLite, MongoDB, and any other server capable of storing, retrieving, and accessing structured or unstructured data. In some implementations, a database server includes table-based servers, document-based servers, unstructured servers, relational servers, non-relational servers, or combinations of these and/or other database servers.

In some implementations, the system includes a variety of data stores and other memory and storage media as discussed above that can reside in a variety of locations, such as on a storage medium local to (and/or resident in) one or more of the computers or remote from any or all of the computers across the network. In some implementations, the information resides in a storage-area network (“SAN”) familiar to those skilled in the art and, similarly, any necessary files for performing the functions attributed to the computers, servers or other network devices are stored locally and/or remotely, as appropriate. In some implementations where a system includes computerized devices, each such device can include hardware elements that are electrically coupled via a bus, the elements including, for example, at least one central processing unit (“CPU” or “processor”), at least one input device (e.g., a mouse, keyboard, controller, touch screen, or keypad), at least one output device (e.g., a display device, printer, or speaker), at least one storage device such as disk drives, optical storage devices, and solid-state storage devices such as random access memory (“RAM”) or read-only memory (“ROM”), as well as removable media devices, memory cards, flash cards, etc., and various combinations thereof.

In some implementations, such a device also includes a computer-readable storage media reader, a communications device (e.g., a modem, a network card (wireless or wired), an infrared communication device, etc.), and working memory as described above where the computer-readable storage media reader is connected with, or configured to receive, a computer-readable storage medium, representing remote, local, fixed, and/or removable storage devices as well as storage media for temporarily and/or more permanently containing, storing, transmitting, and retrieving computer-readable information. In some implementations, the system and various devices also typically include a number of software applications, modules, services, or other elements located within at least one working memory device, including an operating system and application programs, such as a client application or web browser. In some implementations, customized hardware is used and/or particular elements are implemented in hardware, software (including portable software, such as applets), or both. In some implementations, connections to other computing devices such as network input/output devices are employed.

In some implementations, storage media and computer readable media for containing code, or portions of code, include any appropriate media known or used in the art, including storage media and communication media, such as but not limited to volatile and non-volatile, removable and non-removable media implemented in any method or technology for storage and/or transmission of information such as computer readable instructions, data structures, program modules or other data, including RAM, ROM, Electrically Erasable Programmable Read-Only Memory (“EEPROM”), flash memory or other memory technology, Compact Disc Read-Only Memory (“CD-ROM”), digital versatile disk (DVD) or other optical storage, magnetic cassettes, magnetic tape, magnetic disk storage or other magnetic storage devices or any other medium which can be used to store the desired information and which can be accessed by the system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

Other variations are within the spirit of the resent disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed but, on the contrary, the intention is to cover all modifications, alternative constructions, and equivalents falling within the spirit and scope of the invention, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. Similarly, use of the term “or” is to be construed to mean “and/or” unless contradicted explicitly or by context. The terms “comprising,” “having,” “including,” and “containing” are to be construed as open-ended terms (i.e., meaning “including, but not limited to,”) unless otherwise noted. The term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. The use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and the corresponding set may be equal. The use of the phrase “based on,” unless otherwise explicitly stated or clear from context, means “based at least in part on” and is not limited to “based solely on.”

Conjunctive language, such as phrases of the form “at least one of A, B, and C,” or “at least one of A, B and C,” (i.e., the same phrase with or without the Oxford comma) unless specifically stated otherwise or otherwise clearly contradicted by context, is otherwise understood within the context as used in general to present that an item, term, etc., may be either A or B or C, any nonempty subset of the set of A and B and C, or any set not contradicted by context or otherwise excluded that contains at least one A, at least one B, or at least one C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}, and, if not contradicted explicitly or by context, any set having {A}, {B}, and/or {C} as a subset (e.g., sets with multiple “A”). Thus, such conjunctive language is not generally intended to imply that certain embodiments require at least one of A, at least one of B and at least one of C each to be present. Similarly, phrases such as “at least one of A, B, or C” and “at least one of A, B or C” refer to the same as “at least one of A, B, and C” and “at least one of A, B and C” refer to any of the following sets: {A}, {B}, {C}, {A, B}, {A, C}, {B, C}, {A, B, C}, unless differing meaning is explicitly stated or clear from context. In addition, unless otherwise noted or contradicted by context, the term “plurality” indicates a state of being plural (e.g., “a plurality of items” indicates multiple items). The number of items in a plurality is at least two but can be more when so indicated either explicitly or by context.

Operations of processes described herein can be performed in any suitable order unless otherwise indicated herein or otherwise clearly contradicted by context. In some implementations, a process such as those processes described herein (or variations and/or combinations thereof) is performed under the control of one or more computer systems configured with executable instructions and is implemented as code (e.g., executable instructions, one or more computer programs or one or more applications) executing collectively on one or more processors, by hardware or combinations thereof. In some implementations, the code is stored on a computer-readable storage medium, for example, in the form of a computer program comprising a plurality of instructions executable by one or more processors. In some implementations, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In some implementations, code (e.g., executable code or source code) is stored on a set of one or more non-transitory computer-readable storage media having stored thereon executable instructions that, when executed (i.e., as a result of being executed) by one or more processors of a computer system, cause the computer system to perform operations described herein. The set of non-transitory computer-readable storage media, in an embodiment, comprises multiple non-transitory computer-readable storage media, and one or more of individual non-transitory storage media of the multiple non-transitory computer-readable storage media lack all of the code while the multiple non-transitory computer-readable storage media collectively store all of the code. In some implementations, the executable instructions are executed such that different instructions are executed by different processors—for example, a non-transitory computer-readable storage medium stores instructions and a main CPU executes some of the instructions while a graphics processor unit executes other instructions. In another embodiment, different components of a computer system have separate processors and different processors execute different subsets of the instructions.

Accordingly, in an embodiment, computer systems are configured to implement one or more services that singly or collectively perform operations of processes described herein, and such computer systems are configured with applicable hardware and/or software that enable the performance of the operations. Further, a computer system, in an embodiment of the present disclosure, is a single device and, in another embodiment, is a distributed computer system comprising multiple devices that operate differently such that the distributed computer system performs the operations described herein and such that a single device does not perform all operations.

The use of any and all examples or exemplary language (e.g., “such as”) provided herein is intended merely to better illuminate embodiments of the invention and does not pose a limitation on the scope of the invention unless otherwise claimed. No language in the specification should be construed as indicating any non-claimed element as essential to the practice of the invention.

Embodiments of this disclosure are described herein, including the best mode known to the inventors for carrying out the invention. Variations of those embodiments may become apparent to those of ordinary skill in the art upon reading the foregoing description. The inventors expect skilled artisans to employ such variations as appropriate, and the inventors intend for embodiments of the present disclosure to be practiced otherwise than as specifically described herein. Accordingly, the scope of the present disclosure includes all modifications and equivalents of the subject matter recited in the claims appended hereto as permitted by applicable law. Moreover, any combination of the above-described elements in all possible variations thereof is encompassed by the scope of the present disclosure unless otherwise indicated herein or otherwise clearly contradicted by context.

All references including publications, patent applications, and patents cited herein are hereby incorporated by reference to the same extent as if each reference were individually and specifically indicated to be incorporated by reference and were set forth in its entirety herein.

What is claimed is:

1. A method comprising:
obtaining an utterance and a corresponding label representative of an intent of the utterance;
generating, using a first large language model on the utterance and the corresponding label, a prompt comprising a task description and an input-label pair;
modifying the prompt to include one or more of:
a list of known intents;
a few-shot example; or
a list of test examples; and
generating, using a second large language model on the modified prompt, a list of predicted intents;
determining that a particular intent in the list of predicted intents is not in the list of known intents; and
updating the list of known intents with the particular intent.

2. The method of claim 1, wherein the utterance and the corresponding label are retrieved from a training dataset that includes a plurality of utterance-intent pairs for a particular domain.

3. The method of claim 1, wherein utterances corresponding to the list of known intents are semantically similar to utterances in the list of test examples.

4. The method of claim 1, wherein an utterance in the few-shot example is semantically similar to an utterance in at least one of the list of test examples.

5. The method of claim 1, wherein each of the first large language model and the second large language model is a frozen transformer.

6. The method of claim 1, wherein utterances in the list of known intents and utterances in the few-shot example are of a same domain.

7. The method of claim 1, wherein the first large language model is to generate the prompt based on a template.

8. The method of claim 1, wherein the list of test examples includes a plurality of utterances without matching intents, and where at least one of the plurality of utterances is received from a caller via a server in a call center.

9. A system comprising:
one or more processors; and
memory, including computer-executable instructions that, when executed by the one or more processor, cause the system to perform operations comprising:
obtaining an utterance and a corresponding label representative of an intent of the utterance;
generating, using a first large language model on the utterance and the corresponding label, a prompt comprising a task description and an input-label pair;
modifying the prompt to include one or more of:
a list of known intents;
a few-shot example; or
a list of test examples; and
generating, using a second large language model on the modified prompt, a list of predicted intents;
determining that a particular intent in the list of predicted intents is not in the list of known intents; and
updating the list of known intents with the particular intent.

10. The system of claim 9, wherein the utterance and the corresponding label is randomly selected from a training dataset, wherein the training dataset includes a plurality of utterance-intent pairs of a particular domain.

11. The system of claim 9, wherein the utterance and an utterance in the few-shot example are of the same domain.

12. The system of claim 9, wherein the first large language model is to generate the prompt based on a template that specifies a format of a response that the second large language model is to return.

13. The system of claim 9, wherein at least one of a plurality of utterances in the list of test examples is received from a caller via a server in a call center, and wherein the server is to generate a response to the caller using an intent returned by the second large language model based on the at least one utterance.

14. The system of claim 9, wherein the prompt includes a place holder for the few-shot example to be inserted into the prompt, and wherein the prompt further includes one or more instructions instructing the second large language model how to use the few-shot example in discovering intents for the list of test examples.

15. The system of claim 9, wherein the list of known intents include at one intent from a training dataset and at least one intent discovered by the second large language model in a previous iteration.

16. A non-transitory computer-readable storage medium having stored thereon executable instructions which, when executed by one or more processor of a computer system, cause the computer system to perform operations comprising:
obtaining an utterance and a corresponding label representative of an intent of the utterance;
generating, using a first large language model on the utterance and the corresponding label, a prompt comprising a task description and an input-label pair;
modifying the prompt to include one or more of:
a list of known intents;
a few-shot example; or
a list of test examples; and
generating, using a second large language model on the modified prompt, a list of predicted intents;
determining that a particular intent in the list of predicted intents is not in the list of known intents; and
updating the list of known intents with the particular intent.

17. The non-transitory computer-readable storage medium of claim 16, wherein the known intents are a subset of a plurality of known intents stored in a training dataset, wherein the training dataset includes a plurality of utterance-intent pairs of a particular domain.

18. The non-transitory computer-readable storage medium of claim 16, wherein the few-shot example is selected from a few-shot pool that includes a subset of a training dataset, wherein the training dataset includes a plurality of utterance-intent pairs of a particular domain.

19. The non-transitory computer-readable storage medium of claim 16, wherein the updated list of known intents are to be inserted into the prompt.

20. The non-transitory computer-readable storage medium of claim 16, wherein a server in a call center is to obtain the updated list of known intents and is to generate a response to a caller based on the updated list of known intents and an utterance of the caller.
